(19) United States
(12) Patent Application Publication
(10) Pub. No.: US 2013/0088198 A1
(43) Pub. Date: Apr. 11, 2013

(54) ELECTRIC CHARGING SYSTEM AND ELECTRIC CHARGING METHOD

(71) Applicant: Tomokazu Masuda, Kasugai-shi (JP)

(72) Inventor: Tomokazu Masuda, Kasugai-shi (JP)

(73) Assignee: Toyota Jidosha Kabushiki Kaisha, Toyota-shi (JP)

(21) Appl. No.: 13/615,564

(22) Filed: Sep. 13, 2012

(30) Foreign Application Priority Data
Oct. 5, 2011 (JP) 2011-220692

(51) Int. Cl. H02J 7/00

(52) U.S. Cl. 320/109

(57) ABSTRACT

An electric charger converts electric power from an external electric power supply into charging electric power for an electricity storage apparatus. A PLG-ECU determines a charging schedule regarding charging current and charging duration for the electricity storage apparatus based on a necessary amount of charge that is an amount of charge needed in order to complete the charging of the electricity storage apparatus and a scheduled charging end time specified via an input portion, and controls the electric charger based on the charging schedule. The PLG-ECU determines the charging schedule based on a first current that is within the range of current suppliable from the external electric power supply and that is a minimum charging current that is needed in order to supply the necessary amount of charge to the electricity storage apparatus within the duration from the present time to the scheduled charging end time.

### INCORPORATION BY REFERENCE

The disclosure of Japanese Patent Application No. 2011-220692 filed on Oct. 5, 2011 including the specification, drawings and abstract is incorporated herein by reference in its entirety.

### BACKGROUND OF THE INVENTION

1. Field of the Invention

The invention relates to an electric charging system and an electric charging method. More specifically, the invention relates to an electric charging system and an electric charging method in which an electricity storage apparatus mounted in a vehicle is charged from outside the vehicle.

2. Description of Related Art

Vehicles, such as electric motor vehicles, hybrid motor vehicles and fuel-cell motor vehicles, which are constructed to be able to produce vehicle drive force by using an electric motor, are equipped with an electricity storage apparatus that stores electric power for driving the electric motor. In such a vehicle, electric power is supplied from the electricity storage apparatus to the electric motor when the vehicle starts moving or accelerates or the like then drive force of the vehicle is generated, whereas when the vehicle is traveling down a slope or decelerating or the like, the electric power generated by the regenerative braking by the electric motor is supplied to the electricity storage apparatus.

With regard to the aforementioned vehicles, there has been proposed a construction that is capable of being electrically connected to an external electric power supply, such as a commercial electric power supply or the like, so as to allow the charging of the electricity storage apparatus (which hereinafter will also be referred to simply as “external charging”). Among the vehicles capable of the external charging, there exists a vehicle that has a timer-set charging function in which, on the basis of a scheduled charging end time (or a next starting time of vehicle operation) input by a user, the charging of the electricity storage apparatus is finished immediately before the scheduled charging end time.

For example, Japanese Patent No. 3554057 discloses an electric charging control apparatus that controls an electric charger that electrically charges an electric motor vehicle's storage battery. In the electric charging control apparatus described in Japanese Patent No. 3554057, when an electric power supply plug provided for the electric charger is inserted into an electric power supply jack and is therefore connected to an electric power supply, the value of voltage of the power supply connected to the electric charger is detected. Then, if the charging start command is output after a scheduled time to ride into the vehicle is set, a necessary charging duration is computed on the basis of the amount of discharge of the storage battery at the time of output of the charging start command, a detected value of power supply voltage, and a predetermined value of charging current. Furthermore, on the basis of the set scheduled ride-in time and the computed necessary charging duration, a charging start time such that the charging will be finished at or by the scheduled ride-in time is computed. Then, when the charging start time arrives, the charging is started with the value of charging current.

In the construction described in Japanese Patent No. 3554057, the necessary charging duration is computed on the basis of the detected value of voltage of the power supply connected to the electric charger and the predetermined value of charging current. That is, the storage battery is charged with a predetermined constant electric power.

A secondary battery that is typically used as a storage battery has a temperature dependency in which the electric power that the storage battery can accept is restricted when the temperature is low. Therefore, in the case where the external charging is performed in a low-temperature environment, there is possibility that the charging of the storage battery may not be finished by the scheduled charging end time even though the storage battery is charged according to the charging schedule determined on the basis of the predetermined charging electric power.

Furthermore, in the case where the storage battery is charged with electric power supplied from an external power supply at an electric charging station or a user's home, if the electric power that can be output at the charging station or the user's home declines, a predetermined constant electric power cannot be supplied to the storage battery, so that the same problem as stated above can result. For example, in a construction in which a plurality of vehicles are linked to an electric charging station via power cables to charge the electricity storage apparatuses mounted in the vehicles, if the number of vehicles linked to the charging station is increased, there arises a risk that the electric power capacity of the charging station may be exceeded and therefore a prolonged charging duration may result or the charging may be forced to stop.

Incidentally, in order to avoid such an inconvenience, it may be necessary to increase the electric power capacity of the charging station or the user's home. However, that will increase the size of the charging system and raise costs.

### SUMMARY OF THE INVENTION

This invention provides an electric charging system for a vehicle which performs timer-set charging in a simple and efficient construction.

An electric charging system for an electricity storage apparatus mounted in a vehicle in accordance with a first aspect of the invention includes: an electric charger that converts electric power from an external electric power supply into charging electric power for the electricity storage apparatus; an input portion configured to allow a scheduled charging end time for the electricity storage apparatus to be specified; and a control apparatus configured to control the electric charger based on a charging schedule, wherein the control apparatus determines the charging schedule regarding charging current and charging duration for the electricity storage apparatus based on information pieces (i) to (iii) mentioned below: (i) a necessary amount of charge that is an amount of charge that is needed in order to complete charging of the electricity storage apparatus; (ii) the scheduled charging end time; and (iii) a first current that is within a range of current suppliable from the external electric power supply and that is a minimum charging current that is needed in order to supply the necessary amount of charge to the electricity storage apparatus within a duration from a present time to the scheduled charging end time.

In the foregoing electricity charging system, if the charging of the electricity storage apparatus is started at a time that is later than a scheduled charging start time that is set according to the first current and the scheduled charging end time, the control apparatus may change the first current to a minimum current that is needed in order to supply the necessary amount of charge to the electricity storage apparatus within a duration determined by the time at which the charging is actually started and the scheduled charging end time.

The input portion may be configured to allow a scheduled charging start time for the electricity storage apparatus as well as the scheduled charging end time to be specified. If the scheduled charging end time and the scheduled charging start time are specified via the input portion, the control apparatus may determine the charging schedule based on a second current that is within the range of current suppliable from the external electric power supply and that is a minimum charging current that is needed in order to supply the necessary amount of charge to the electricity storage apparatus within a duration determined by the scheduled charging start time and the scheduled charging end time.

Furthermore, in the foregoing electric charging system, if the charging of the electricity storage apparatus is started at a time that is later than the scheduled charging start time specified via the input portion, the control apparatus may change the second current to a minimum current that is needed in order to supply necessary amount of charge to the electricity storage apparatus within a duration determined by the time at which the charging is actually started and the scheduled charging end time.

Still further, when the vehicle and the external electric power supply are connected by a charging cable, the control apparatus may detect a range of current that is able to be conducted by the charging cable as the range of current suppliable from the external electric power supply.

The range of current suppliable from the external electric power supply may be greater than or equal to a minimum value of current that the external electric power supply supplies and less than or equal to a rated current of the charging cable that connects the vehicle and the external electric power supply.

An electric charging method for an electricity storage apparatus mounted in a vehicle in accordance with a second aspect of the invention includes: determining a charging schedule regarding charging current and charging duration for the electricity storage apparatus based on information pieces (i) to (iii) mentioned below: (i) a necessary amount of charge that is an amount of charge that is needed in order to complete charging of the electricity storage apparatus, (ii) a scheduled charging end time for the electricity storage apparatus, and (iii) a first current that is within a range of current suppliable from an external electric power supply and that is a minimum charging current that is needed in order to supply the necessary amount of charge to the electricity storage apparatus within a duration from a present time to the scheduled charging end time; and controlling an electric charger based on the charging schedule, wherein the electric charger converts electric power from the external electric power supply into charging electric power for the electricity storage apparatus.

According to the foregoing aspects of the invention, an electric charging system for a vehicle that executes the tinier-set charting can be constructed in a simple and efficient manner.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram of an electric charging system for an electric vehicle which is an embodiment of the invention;

FIG. 2 is a diagram illustrating a construction of an electric charger shown in FIG. 1;

FIGS. 3A and 3B are diagrams illustrating a timer-set charging control executed by a PLG-ECU in this embodiment;

FIG. 4 is a flowchart showing a control processing procedure of the timer-set charging control according to the embodiment;

FIG. 5 is a diagram showing an example of a table for calculating the minimum charging current;

FIG. 6 is a conceptual diagram for describing a first modification of the adjustment of the charging current that is executed by the PLG-ECU;

FIG. 7 is a flowchart showing a processing procedure of a timer-set charging control executed by the PLG-ECU in an electric charging system in accordance with the first modification of the embodiment;

FIG. 8 is a conceptual diagram for describing a second modification of the adjustment of the charging current executed by the PLG-ECU;

FIG. 9 is a flowchart showing a processing procedure of a timer-set charging control executed by the PLG-ECU in an electric charging system in accordance with the second modification of the embodiment;

FIG. 10 is a conceptual diagram for describing a third modification of the adjustment of the charging current that is executed by the PLG-ECU; and

FIG. 11 is a flowchart showing a processing procedure of a timer-set charging control executed by the PLG-ECU in an electric charging system in accordance with a third modification of the embodiment.

### DETAILED DESCRIPTION OF EMBODIMENTS

Embodiments of the invention will be described in detail hereinafter with reference to the drawings. The same or comparable portions in the drawings are denoted by the same reference characters, and descriptions thereof will not be repeated below.

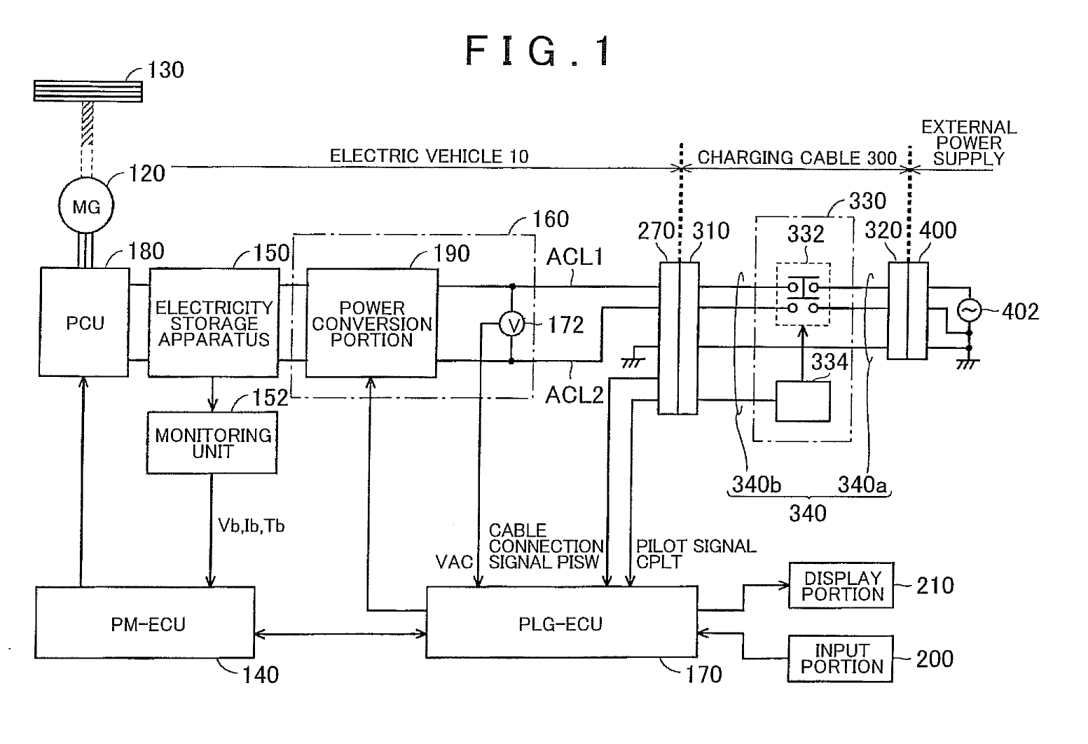

FIG. 1 is a schematic diagram of an electric charging system for an electric vehicle 10 which is an embodiment of the invention. The construction of the electric vehicle 10 is not particularly limited as long as the electric vehicle 10 is capable of traveling by electric power from an electricity storage apparatus that is capable of being charged by an external electric power supply. The electric vehicle 10 may be any one of various types of electric vehicles, for example, a hybrid motor vehicle, an electric motor vehicle, a fuel-cell motor vehicle, etc.

Referring to FIG. 1, the electric vehicle 10 is equipped with an electricity storage apparatus 150 that stores electric power for use for producing vehicle drive force, a motor-generator (MG) 120 for producing drive force, an electric power conversion unit (PCU) 180, a driving wheel 130 to which drive force produced by the motor-generator 130 is transmitted, an input portion 200, a display portion 210, a PM (power train management)-ECU (electronic control unit) 140 for controlling the overall operation of the electric vehicle 10.

Furthermore, in order to perform the charging from an external electric power supply, the electric vehicle 10 also includes a vehicle's electrical inlet 270 provided in a body of the electric vehicle 10, an electric charger 160 for charging the electricity storage apparatus 150 from the external electric power supply, and a PLG-ECU 170. Incidentally, the external electric power supply is typically composed of a single-phase commercial electric power supply. Instead of or in addition to using the commercial electric power supply, electricity generation by solar battery panels installed on a roof of a house or the like may be utilized to supply electric power of the external power supply.

The electricity storage apparatus 150 is an electric power storage element constructed to be rechargeable and, typically, is a secondary battery such as a lithium-ion battery, a nickel metal hydride battery, etc. Alternatively, the electricity storage apparatus 150 may be constructed by an electric power storage element that is other than the batteries, such as an electric double-layer capacitor or the like. FIG. 1 shows a system construction related to a charging/discharging control of the electricity storage apparatus 150 in the electric vehicle 10. The electricity storage apparatus 150 is provided with a battery sensor (not shown) for detecting the voltage Vb, the current Ib and the temperature Tb of the electricity storage apparatus 150.

A monitoring unit 152 detects a state value of the electricity storage apparatus 150 on the basis of the output of the battery sensor provided in the electricity storage apparatus 150. That is, the state value includes the voltage Vb, the current Ib and the temperature Tb of the electricity storage apparatus 150. Since a secondary battery is typically used as the electricity storage apparatus 150 as stated above, the voltage Vb, the current Ib and the temperature Tb of the electricity storage apparatus 150 will also be termed the battery voltage Vb, the battery current Ib and the battery temperature Tb. Furthermore, the battery voltage Vb, the battery current Ib and the battery temperature Tb will also be collectively referred to as “battery data”. The state value (battery data) of the electricity storage apparatus 150 detected by the monitoring unit 152 is input to the PM-ECU 140.

The PCU 180 is constructed so as to convert electric power in both ways between the motor-generator 120 and the electricity storage apparatus 150. Concretely, the PCU 180 converts the direct-current electric power from the electricity storage apparatus 150 into alternating-current electric power for driving the motor-generator 120. The PCU 180 also converts the alternating-current electric power generated by the motor-generator 120 into direct-current electric power for charging the electricity storage apparatus 150.

The motor-generator 120 is typically constructed by a permanent magnet type three-phase synchronous electric motor. Output torque of the motor-generator 120 is transmitted to the driving wheel 130 via a power transmission gear (not shown) to move the electric vehicle 10. The motor-generator 120 generates electricity by using rotating force of the driving wheel 130 during the regenerative braking of the electric vehicle 10. The generated electric power is converted by the PCU 180 into charging electric power for the electricity storage apparatus 150.

Incidentally, in a hybrid motor vehicle equipped with an engine (not shown) besides the motor-generator 120, necessary vehicle drive force is produced by operating the engine and the motor-generator 120 in a coordinated manner. In such a case, the electricity storage apparatus 150 can be charged by using the electric power generated by operation of the engine.

The PM-ECU 140 includes a central processing unit (CPU), a storage device and an input/output buffer, none of which is shown in the drawings. The PM-ECU 140 accepts input of signals from various sensors and the like, and outputs control signals to various appliances, and also controls the electric vehicle 10 and the various appliances. Incidentally, controls of the electric vehicle 10 and the various appliances can be processed not only by software but also by dedicated hardware devices (electronic circuits).

The PM-ECU 140 computes the state of charge (SOC) of the electricity storage apparatus 150 on the basis of the battery data (Vb, Ib, and Tb) input from the monitoring unit 152. The SOC is the percentage (0 to 100%) of the present state of charge to the full state of charge. In this embodiment, an empty state of the electricity storage apparatus 150 is defined as SOC=0%, and the frilly charged state of the electricity storage apparatus 150 is defined as SOC=100%. Incidentally, calculation of the SOC of the electricity storage apparatus 150 can be carried out by employing an arbitrary known technique, and will not be described in detail.

The PM-ECU 140, during travel of the electric vehicle 10, controls the motor-generator 120 and the PCU 180 in order to cause production of vehicle drive force commensurate with demand of the driver. In addition to the control of the vehicle drive force, the PM-ECU 140 controls the electric power with which the electricity storage apparatus 150 is charged or discharged. Besides, during the external charging, the PM-ECU 140 controls the charging electric power of the electricity storage apparatus 150 so that the electricity storage apparatus 150 reaches the fully charged state.

The electric charger 160 is an apparatus that charges the electricity storage apparatus 150 by receiving electric power from an external electric power supply 402. The electric charger 160 includes a voltage sensor 172 and an electric power conversion portion 190. The electric power conversion portion 190 is connected to the vehicle's electrical inlet 270 by electric power lines ACL1 and ACL2 via a relay (not shown), and is also connected to the electricity storage apparatus 150. The voltage sensor 172 is disposed between the electric power lines ACL1 and ACL2. A detected value VAC of voltage detected by the voltage sensor 172 (the supply voltage from the external electric power supply) is input to the PLG-ECU 170. Furthermore, a cable connection signal PISW and a pilot signal CPLT from the side of a charging cable 300 are input to the PLG-ECU 170 via the vehicle's electrical inlet 270.

The electric power conversion portion 190, following the control command from the PM-ECU 140, converts the alternating-current electric power from the external electric power supply 402 transferred through the charging cable 300 and via the vehicle's electrical inlet 270, the electric power lines ACL1 and ACL2 and the relay, into direct-current electric power for charging the electricity storage apparatus 150.

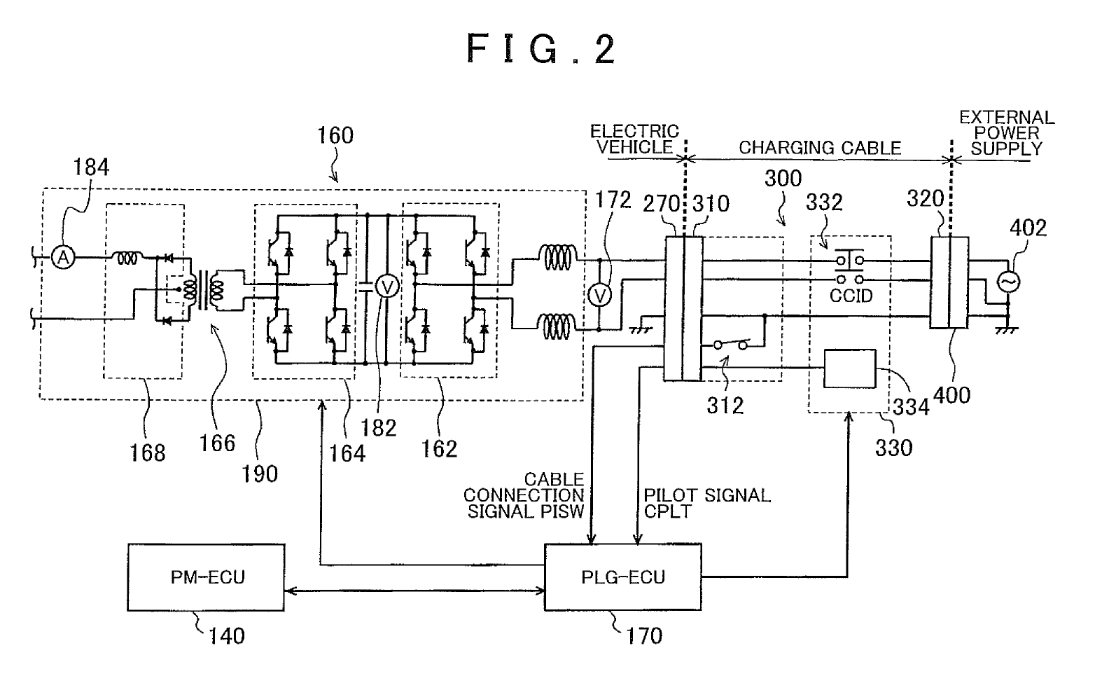

With reference to FIG. 2, the electric charger 160 will be further described. The electric charger 160 includes the voltage sensor 172 and the electric power conversion portion 190. The electric power conversion portion 190 includes an AC/DC conversion circuit 162, a DC/AC conversion circuit 164, an isolation transformer 166 and a rectifier circuit 168.

The AC/DC conversion circuit 162 is made up of a single-phase bridge circuit. The AC/DC conversion circuit 162 converts alternating-current electric power into direct-current electric power on the basis of a drive signal from the PM-ECU 140. Furthermore, the AC/DC conversion circuit 162 also functions as a boost chopper circuit that raises voltage by using the coils as rectors.

The DC/AC conversion circuit 164 is made up of a single-phase bridge circuit. The DC/AC conversion circuit 164 converts the direct-current electric power into high-frequency alternating-current electric power and outputs it to the isolation transformer 166 on the basis of a drive signal from the PM-ECU 140.

The isolation transformer 166 includes a core made of a magnetic substance, and a primary coil and a secondary coil that are wound around the core. The primary coil and the secondary coil are electrically isolated from each other, and are connected to the DC/AC conversion circuit 164 and the rectifier circuit 168, respectively. The isolation transformer 166 converts the high-frequency alternating-current electric power from the DC/AC conversion circuit 164 into a voltage level commensurate with the turns ratio between the primary coil and the secondary coil, and outputs the converted voltage to the rectifier circuit 168. The rectifier circuit 168 rectifies the alternating-current electric power input from the isolation transformer 166 into direct-current electric power.

The voltage between the AC/DC conversion circuit 162 and the DC/AC conversion circuit 164 (the inter-terminal voltage of a smoothing capacitor) is detected by a voltage sensor 182, and the detected voltage value is input to the PLG-ECU 170. Furthermore, the output current of the electric charger 160 (that corresponds to the charging current for the electricity storage apparatus 150) Ich is detected by a current sensor 184, and the detected electric current value is input to the PLG-ECU 170.

The charging cable 300 is provided with a vehicle-side charging connector 310, an external electric power supply-side plug 320, a charging circuit interrupter device (CCID) 330, and an electric line portion 340 that connects various appliances for the purpose of inputting and outputting electric power and control signals. The electric line portion 340 includes an electric line portion 340a that connects the plug 320 and the CCID 330, and an electric line portion 340b that connects the charging connector 310 and the CCID 330.

The charging connector 310 is constructed to be connectable to the vehicle's electrical inlet 270 that is provided on the body of the electric vehicle 10. The charging connector 310 is provided with a switch 312. When the charging connector 310 is connected to the vehicle's electrical inlet 270, the switch 312 closes, so that a cable connection signal PISW that indicates that the charging connector 310 has been connected to the vehicle's electrical inlet 270 is input to the PLG-ECU 170.

The plug 320 is connected to an electric power supply outlet 400 that is provided, for example, in a house. The power supply outlet 400 is supplied with alternating-current electric power from the external electric power supply 402.

The CCID 330 includes a CCID relay 332 and a control pilot circuit 334. The CCID relay 332 is provided on a pair of electric power lines within the charging cable 300. The CCID relay 332 is on/off controlled by the control pilot circuit 334. When the CCID relay 332 is off, the electrical path is interrupted in the charging cable 300. On the other hand, when the CCID relay 332 is turned on, it becomes possible to supply electric power from the external electric power supply 402 to the electric vehicle 10.

The control pilot circuit 334 outputs a pilot signal CPLT to the PLG-ECU 170 of the vehicle via the charging connector 310 and the vehicle's electrical inlet 270. This pilot signal CPLT is a signal for notifying the rated current of the charging cable 300 from the control pilot circuit 334 to the PLG-ECU 170 of the vehicle. In detail, the control pilot circuit 334 includes an oscillator (not shown), and outputs a signal that oscillates at a prescribed frequency and in a duty cycle when the electric potential of the pilot signal CPLT declines from a prescribed potential. The duty cycle of the pilot signal CPLT is set on the basis of the rated current that can be supplied from the external electric power supply 402 to the electric vehicle 10 via the charging cable 300. The rated current is determined for each charging cable, and different kinds of charging cables have different rated currents. Therefore, the duty cycle of the pilot signal CPLT differs from one charging cable to another.

Furthermore, the pilot signal CPLT is also used as a signal for remotely manipulating the CCID relay 332 from the PLG-ECU 170 on the basis of the potential of the pilot signal CPLT manipulated by the PLG-ECU 170. The control pilot circuit 334 on/off controls the CCID relay 332 on the basis of changes in the potential of the pilot signal CPLT. That is, the pilot signal CPLT is sent and received between the PLG-ECU 170 and the CCID 330.

The PLG-ECU 170 and the PM-ECU 140 are connected via a communication bus (not shown) so that communication therebetween is possible in two directions. The PLG-ECU 170, upon acquiring the cable connection signal PISW and the pilot signal CPLT as well as the detected value VAC from the voltage sensor 172, sends these acquired pieces of information to the PM-ECU 140. The PLG-ECU 170 controls the operation of the electric charger 160 during the external charging, on the basis of the acquired information. As a result, the electric charger 160, following the control command from the PLG-ECU 170, converts the electric power from the external electric power supply 402 into an electric power suitable to charge the electricity storage apparatus 150. Concretely, the electric charger 160 generates direct-current voltage by rectifying the supply voltage of the external electric power supply 402, and controls the charging current Ich to be supplied to the electricity storage apparatus 150, in accordance with the control command from the PLG-ECU 170.

Although in the above-described embodiment, the PM-ECU 140 and the PLG-ECU 170 are separate ECUs, there may also be provided an ECU that performs all the functions of the ECUs mentioned above.

Referring back to FIG. 1, the display portion 210 is a user interface that displays pieces of display information (information to be displayed) from the PLG-ECU 170, such as the charging duration of the electricity storage apparatus 150 computed by the PLG-ECU 170 in a timer-set charging control described below, the charging start time set according to the charging duration, etc. The display portion 210 includes indicators, such as display lamps, LEDs, etc., or includes a liquid crystal display or the like.

The input portion 200 is a user interface for setting the scheduled charging end time (or the next scheduled vehicle driving start time) in the timer-set charging control (described below). The scheduled charging end time set by the input portion 200 is sent to the PLG-ECU 170.

Incidentally, although in FIG. 1 the input portion 200 and the display portion 210 are shown as different elements, these portions may be integrated into one element.

Furthermore, instead of the construction shown in FIGS. 1 and 2, there may be provided a construction in which the external electric power supply 402 and the electric vehicle 10 are electromagnetically coupled in a non-contact manner so as to supply electric power and, concretely, a construction in which a primary coil is provided at the external electric power supply side and a secondary coil is provided at the vehicle side, and electric power is supplied from the external electric power supply 402 to the electric vehicle 10 by utilizing the mutual inductance between the primary coil and the secondary coil. In the case where the external charging is performed in this manner, too, the construction that includes the electric charger 160 that converts the supply electric power from the external electric power supply 402 and the arrangement downstream of the electric charger 160 can be maintained as a common construction.

(TIMER-SET CHARGING CONTROL) The electric vehicle in accordance with this embodiment is a vehicle capable of the external charging. Therefore, after the vehicle completes a travel, the distance that the electric vehicle is able to travel by using the electric power stored in the electricity storage apparatus 150 can be increased by storing as much electric power as possible in the electricity storage apparatus 150.

However, generally in the secondary batteries typically used as electricity storage apparatuses as described above, continuation of the state of high SOC for a long time is not preferable in terms of degradation of the batteries. Therefore, in the electric vehicle 10 in accordance with the embodiment, the PLG-ECU 170 executes a charging control (timer-set charging control) of the electricity storage apparatus 150 on the basis of a scheduled charging end time specified by a user so that the SOC reaches a predetermined fully charged state immediately before the scheduled charging end time.

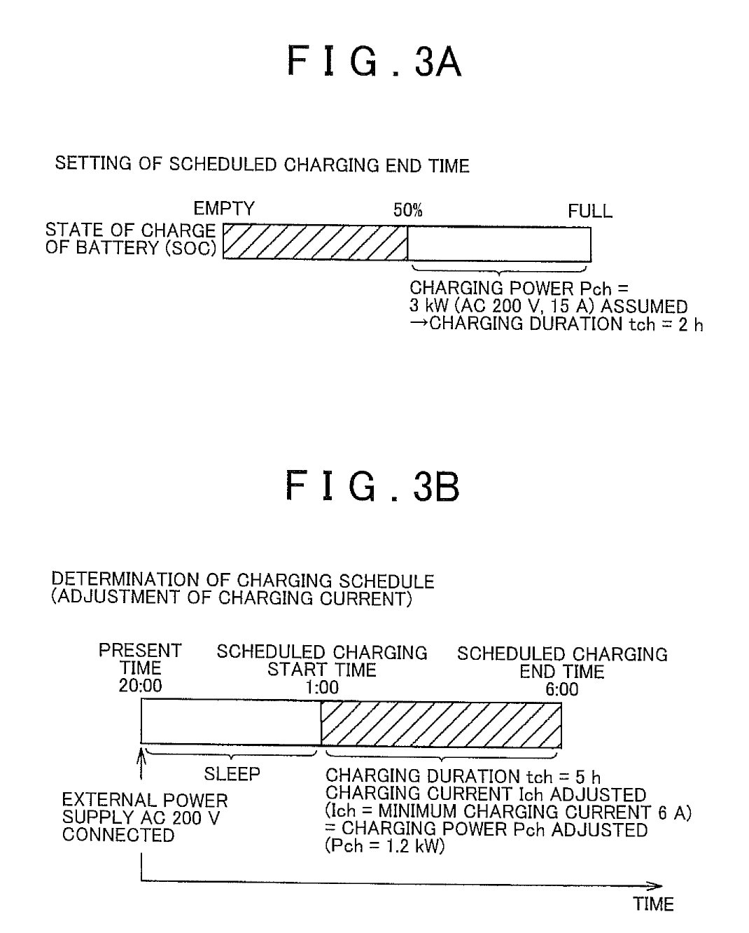

FIGS. 3A and 3B are diagrams illustrating the timer-set charging control executed by the PLG-ECU 170 in this embodiment.

Referring to FIG. 3A, if a user sets a scheduled charging end time via the input portion 200 after the electric vehicle 10 completes a travel, the PM-ECU 140 computes the SOC of the electricity storage apparatus 150 on the basis of the battery data (Vb, Ib and Tb) from the monitoring unit 152 (FIG. 1). In FIG. 3A, the amount of charge remaining in the electricity storage apparatus 150 before charging is started is SOC=50%. In the following description, the case where the electricity storage apparatus 150 is charged from the state of SOC=50% to the fully charged state, that is, SOC=100%, will be considered.

The PLG-ECU 170 computes a necessary amount of charge that is needed in order to charge the electricity storage apparatus 150 to the fully charged state, on the basis of the SOC of the electricity storage apparatus 150 computed by the PM-ECU 140.

Next, on the basis of the necessary amount of charge for the electricity storage apparatus 150 and the scheduled charging end time, the PLG-ECU 170 determines a charging schedule with respect to a charging current Ich and a charging duration tch for the electricity storage apparatus 150. The determination of the charging schedule by the PLG-ECU 170 will be described below with reference to FIG. 3B.

The PLG-ECU 170, on the basis of the necessary amount of charge, computes a charging duration tch required in the case where the electricity storage apparatus 150 is charged with a constant charging electric power Pch. This charging electric power Pch is determined on the basis of the electric power that can be supplied from the electric charger 160. Concretely, after the PLG-ECU 170 determines on the basis of the cable connection signal PISW that the charging connector 310 of the charging cable 300 has been connected to the vehicle's electrical inlet 270, the PLG-ECU 170 acquires a detected value VAC of the voltage from the voltage sensor 172 (supply voltage from the external electric power supply 402). The PLG-ECU 170 also acquires the rated current that can be supplied to the electric vehicle 10 through the charging cable 300, on the basis of the duty cycle of the pilot signal CPLT. The PLG-ECU 170 sets the charging electric power Pch (charging current Ich) on the basis of the supply voltage VAC from the external electric power supply 402 and the rated current of the charging cable 300.

FIG. 3A assumes a case where the supply voltage VAC from the external electric power supply 402 is an alternating-current voltage of 200 V and the rated current of the charging cable 300 is 15 A. In this case, the maximum electric power that can be supplied from the external electric power supply 402 (hereinafter, also referred to as “maximum supply electric power”) is 3 kW(=200 V×15 A), Incidentally, it is assumed that the necessary charging duration tch is calculated to be 2 hours in the case where the charging current Ich is set to the rated current (15 A) of the charging cable 300 and the electricity storage apparatus 150 is charged with that setting (i.e., in the case where the electricity storage apparatus 150 is charged by setting the charging electric power Pch at the maximum supply electric power).

The PLG-ECU 170 adjusts the charging current Ich within the range of current that can be supplied from the external electric power supply 402 on the basis of a chargeable duration tcha from the present time to the scheduled charging end time. For example, in the case where the present time is 20:00 and the user sets the scheduled charging end time to 6:00 in the next morning, the chargeable duration tcha is 10 hours.

The range of current that can be supplied to the electric charger 160 has an upper limit equal to the rated current of the charging cable 300 and a lower limit equal to the minimum current that can be supplied from the external electric power supply 402 (hereinafter, also referred to as “minimum supply current”). The minimum supply current is determined by taking into account the characteristic of the electric charger 160, the charging efficiency of the electricity storage apparatus 150, etc.

For example, if the minimum supply current is 6 A, the range of current that can be supplied from the external electric power supply 402 is greater than or equal to 6 A (minimum supply current) and less than or equal to 15 A (rated current). Therefore, if the supply voltage VAC from the external electric power supply 402 is 200 V, the range of electric power that the electric charger 160 can supply is greater than or equal to 1.2 kW (minimum supply electric power) and less than or equal to 3 kW (maximum supply electric power).

The PM-ECU 140, after acquiring the range of current that the external electric power supply 402 can supply, computes within this range of current the smallest charging current that allows the necessary amount of charge to be supplied to the electricity storage apparatus 150 within the chargeable duration (10 h) from the present time (20:00) to the scheduled charging end time (6:00 in the next morning) (the smallest charging current will hereinafter be also referred to as “minimum charging current”).

Referring to FIG. 3B, the charging duration tch needed in the case where the charging current Ich is set to the minimum supply current of 6 A is 5 hours. This charging duration tch is shorter than the chargeable duration (10 h). That is, even if the charging current Ich is set to the minimum supply current, the charging of the electricity storage apparatus 150 can be completed at the scheduled charging end time (6:00 in the next morning). Therefore, the minimum charging current=the minimum supply current (6 A).

Next, the PM-ECU 140 calculates the charging duration tch (5 h) on the basis of the minimum charging current (6 A) and the necessary amount of charge. Then, on the basis of the calculated charging duration tch (5 h) and the scheduled charging end time, the PM-ECU 140 determines a scheduled charging start time. In the case where the scheduled charging end time is set to 6:00 in the next morning by the user, the scheduled charging start time is determined as 1:00 in the morning by subtracting the charging duration tch (5 h) from the scheduled charging end time. The PLG-ECU 170 outputs the determined scheduled charging start time (1:00), the charging duration tch (5 h) and the scheduled charging end time (6:00 in the next morning) as display information to the display portion 210 (FIG. 1). Due to this, the foregoing display information is displayed on the screen of the display portion 210.

The PLG-ECU 170 executes a timer-set electric charging process by using the scheduled charging start time. Concretely, the PLG-ECU 170 keeps the electric vehicle 10 in a charging standby state (sleep) from the time (20:00) at which the charging cable 300 is connected to the electric vehicle 10 until the scheduled charging start time (1:00 in the morning). Then, when the scheduled charging start time (1:00 in the morning) is reached, the PLG-ECU 170 charges the electricity storage apparatus 150 by driving the electric charger 160.

At this time, the PLG-ECU 170 feedback controls the electric power conversion portion 190 of the electric charger 160 so that the charging current Ich detected by the electric current sensor 184 (FIG. 2) becomes equal to the minimum charging current (6 A). Concretely, the PLG-ECU 170 performs a proportional integration (PI) computation with respect to the deviation (current deviation) of the charging current Ich from the minimum charging current, and generates a drive signal for driving the electric power conversion portion 190 on the basis of a result of the PI computation, and thereby controls the electric power conversion portion 190. Due to this, after the external charging is started, the electricity storage apparatus 150 is charged with a constant charging electric power Pch (1.2 kW). Then, at 6:00 in the next morning, which is the scheduled charging end time, the charging of the electricity storage apparatus 150 ends.

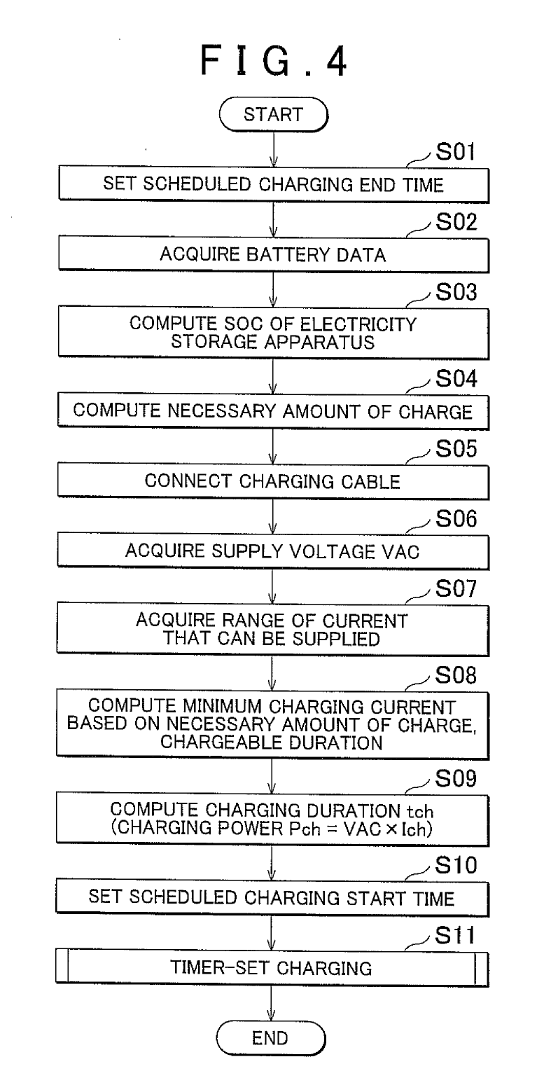

FIG. 4 is a flowchart showing a control processing procedure of the timer-set charging control according to the embodiment.

Referring to FIG. 4, the PLG-ECU 170 acquires a scheduled charging end time specified by a user in step S01. In step S02, the PM-ECU 140 acquires the battery data (Vb, Ib and Tb) from the monitoring unit 152. In step S03, the PM-ECU 140 computes the present SOC of the electricity storage apparatus 150 on the basis of the acquired battery data. The PLG-ECU 170 acquires the present SOC of the electricity storage apparatus 150 from the PM-ECU 140.

In step S04, the PLG-ECU 170, on the basis of the present SOC of the electricity storage apparatus 150, computes the necessary amount of charge that is needed in order to charge the electricity storage apparatus 150 to the fully charged state.

Next, after in step S05 the PLG-ECU 170 determines that the charging connector 310 of the charging cable 300 has been connected to the vehicle's electrical inlet 270 on the basis of the cable connection signal PISW, the PLG-ECU 170 acquires in step S06 the detected value VAC of the voltage from the voltage sensor 172 (supply voltage from the external electric power supply 402). Then, in step S07, the PLG-ECU 170 acquires the rated current that can be supplied to the electric vehicle 10 through the charging cable 300, on the basis of the duty cycle of the pilot signal CPLT. Through the process of step S07, the PLG-ECU 170 acquires the range of current that the external electric power supply 402 can supply and that is determined by the rated current of the charging cable 300 and the minimum supply current.

In step S08, the PLG-ECU 170 computes, within the range of current that the external electric power supply 402 can supply, a minimum charging current that allows the necessary amount of charge to be supplied to the electricity storage apparatus 150 within the chargeable duration from the present time to the scheduled charging end time.

After the PLG-ECU 170 calculate the charging duration tch on the basis of the computed minimum charging current and the necessary amount of charge in step S09, the PLG-ECU 170 determines the scheduled charging start time in step S10 on the basis of the calculated charging duration tch and the scheduled charging end time. The PLG-ECU 170 the proceeds to step S11, in which the PLG-ECU 170 executes the timer-set electric charging process by using the scheduled charging start time.

Thus, in the electric charging system for a vehicle according to the embodiment, when the scheduled charging end time is specified, a charging schedule is determined on the basis of the minimum charging current that allows the necessary amount of charge to be supplied in the chargeable duration from the present time to the scheduled charging end time by using a current within the range of current that can be supplied from the external electric power supply. The charging of the electricity storage apparatus 150 is controlled on the basis of the charging schedule. This construction makes it possible to charge the electricity storage apparatus 150 according to the charging schedule even in the case where there occurs a decrease in the electric power that can be output at the electric charging station or a user's home or the like, or in the case where the electric power that the electricity storage apparatus 150 can accept is restricted due to a low-temperature environment or the like. As a result, the incidence of adverse events in which the charging of the electricity storage apparatus 150 does not end at the scheduled charging end time can be reduced in comparison with the construction in which the electricity storage apparatus 150 is charged with the charging current Ich that is set to the rated current of the charging cable.

Furthermore, in the case where a construction adopted for the external charging is a construction in which a vehicle and an external electric power supply are electrically connected by linking the vehicle to an electric charging station or a user's home via an electric power line, it is no longer necessary to increase the electric power capacity of the electric charging station or the user's home, and therefore it becomes possible to efficiently construct an electric charging system in a reduced size and at a lower cost.

The foregoing embodiment has a construction in which at the time point at which the electric vehicle 10 and the external electric power supply 402 are connected by the charging cable 300, the PLG-ECU 170 computes the minimum charging current on the basis of the necessary amount of charge and the chargeable duration. However, another construction may also be adopted in which a table in which the charging current, the amount of charge remaining in the electricity storage apparatus 150 and the charging duration correspond to one another is acquired beforehand and the minimum charging current is calculated with reference to the table on the basis of the amount of remaining charge and the chargeable duration.

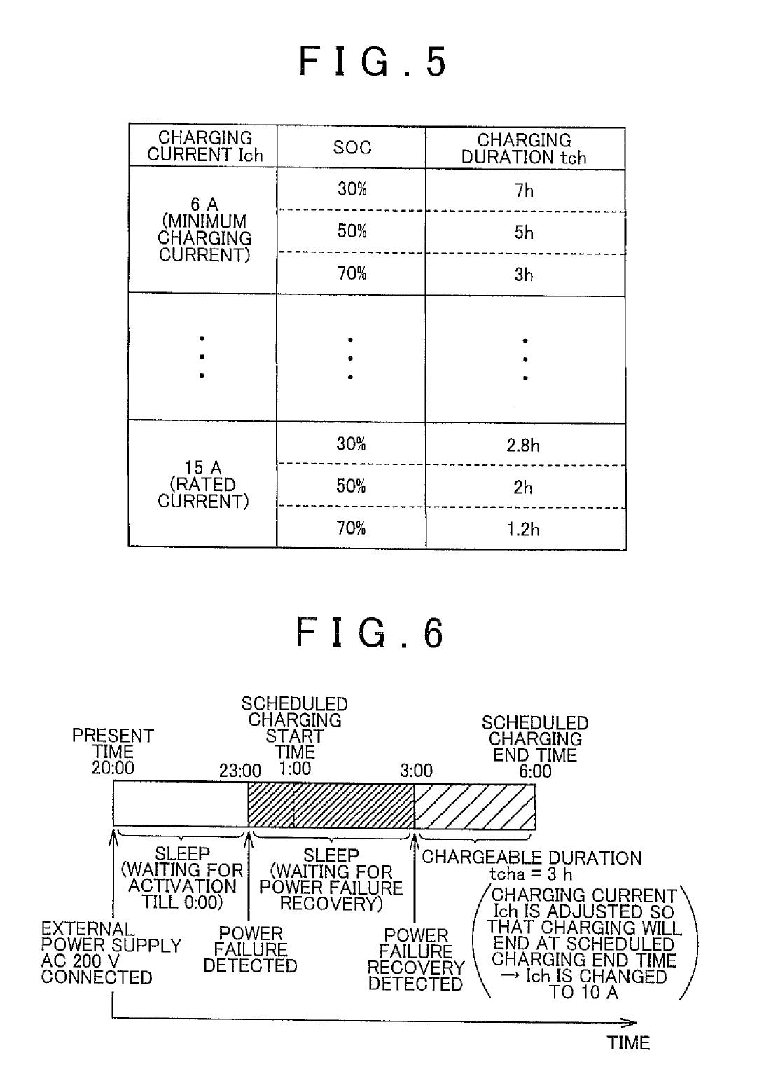

FIG. 5 shows an example of a table for calculating the minimum charging current. Referring to FIG. 5, the charging current is set so as to change stepwise within a range of current that the external electric power supply 402 is able to supply. The charging duration is calculated separately for each step value of the charging current on the basis of the amount of remaining charge of the electricity storage apparatus 150. The PLG-ECU 170, after acquiring the scheduled charging end time and the SOC of the electricity storage apparatus 150, is able to calculate the minimum charging current with reference to the table shown in FIG. 5 on the basis of the chargeable duration from the present time to the scheduled charging end time and the SOC of the electricity storage apparatus 150.

FIRST MODIFICATION In the foregoing embodiment, the minimum charging current is calculated on the basis of the necessary amount of charge and the chargeable duration, and the scheduled charging start time calculated on the basis of the minimum charging current is used to perform the timer-set electric charging process. However, if the external electric power supply 402 fails and the supply of electric power to the electricity storage apparatus 150 is temporarily shut down until the failure is recovered, the chargeable duration during which the external electric power supply 402 can charge the electricity storage apparatus 150 becomes shorter than the chargeable duration set in the charging schedule. Therefore, there is possibility of the electricity storage apparatus 150 not having reached the frilly charged state at the scheduled charging end time.

In a first modification, in the case where the chargeable duration of the electricity storage apparatus 150 is shorter than the scheduled charging duration, the PLG-ECU 170 adjusts the charging current Ich according to the chargeable duration so that the charging ends at the scheduled charging end time.

FIG. 6 is a conceptual diagram for describing a first modification of the adjustment of the charging current Ich that is executed by the PLG-ECU 170. FIG. 6 assumes a case where the external electric power supply 402 fails when the timer-set electric charging process is being executed according to the charging schedule shown in FIG. 3B (in which the scheduled charging start time is set to 1:00 in the morning and the scheduled charging end time is set to 6:00 in the same morning).

Referring to FIG. 6, the assumed case is specifically a case where the supply of electric power to the electricity storage apparatus 150 is interrupted for the period from 23:00, at which the failure of the external electric power supply 402 is detected, to 3:00 in the next morning, at which the recovery from the failure is detected. In this case, the chargeable duration otcha of the electricity storage apparatus 150 is the time period (3 h) from the time (3:00 in the morning) of detection of the recovery from the failure to the scheduled charging end time (6:00 in the morning), and is therefore shorter than the originally scheduled charging duration tch (5 h). Therefore, at the scheduled charging end time, the charging of the electricity storage apparatus 150 has not been completed.

In the first modification, the PLG-ECU 170, upon detecting recovery from the failure, computes the chargeable duration tcha from the time of detection of the recovery from the failure (3:00 in the morning) to the scheduled charging end time (6:00 in the morning). Then, the PLG-ECU 170 changes the charging current Ich on the basis of the chargeable duration tcha. At this time, the PLG-ECU 170 changes the charging current Ich to a minimum charging current that allows the necessary amount of charge to be supplied to the electricity storage apparatus 150 within the chargeable duration tcha. In FIG. 6, since the chargeable duration tcha has become shorter than the charging duration tch set on the charging schedule, the charging current Ich is adjusted to a current (10 A) that is larger than the minimum charging current (6 A) set prior to the detection of the failure. That is, the charging electric power Pch is adjusted to an electric power (2 kW) that is larger than the pre-failure-detection charging electric power (1.2 kW).

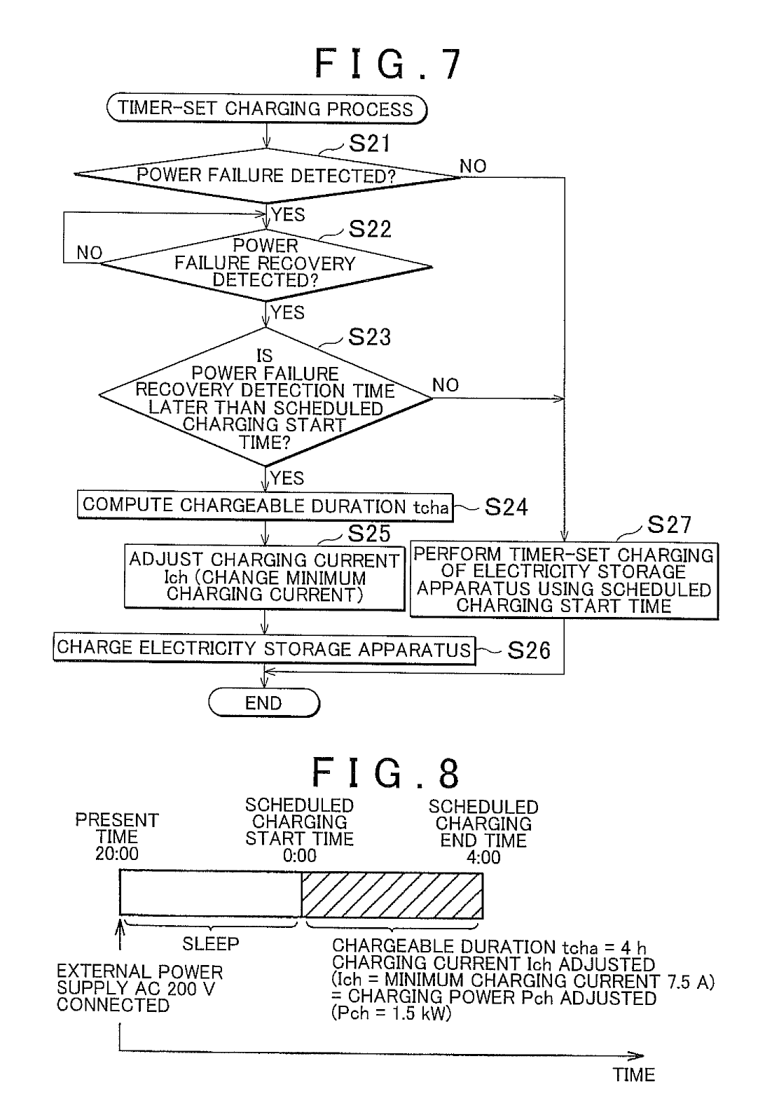

FIG. 7 is a flowchart showing a processing procedure of a timer-set charging control executed by the PLG-ECU 170 in an electric charging system in accordance with the first modification.

Referring to FIG. 7, in step S21, the PLG-ECU 170 determines whether failure of the external electric power supply 402 has been detected. If failure of the external electric power supply 402 is not detected (if the answer to step S21 is NO), the PLG-ECU 170 proceeds to step S27, in which the PLG-ECU 170 executes the timer-set electric charging process by using the scheduled charging start time set in the process shown by the flowchart in FIG. 4.

On the other hand, if failure of the external electric power supply 402 is detected (if the answer to step S21 is YES), the PLG-ECU 170 determines in step S22 whether recovery from the power failure is detected. If recovery from the power failure is detected (if the answer to step S22 is YES), the PLG-ECU 170 subsequently determines in step S23 whether the time of detection of the recovery from the power failure is later than the scheduled charging start time. If the power failure recovery detection time is earlier than the scheduled charging start time (if the answer to step S23 is NO), the PLG-ECU 170 proceeds to step S27, in which the PLG-ECU 170 executes the timer-set electric charging process.

On the other hand, if the power failure recovery detection time is later than the scheduled charging start time (if the answer to step S23 is YES), the PLG-ECU 170 computes in step S24 the chargeable duration tcha from the power failure recovery detection time to the scheduled charging end time. Then, in step S25, the PLG-ECU 170 adjusts the charging current Ich according to the chargeable duration tcha so that the charging will be completed within the chargeable duration tcha.

In step S25, the PLG-ECU 170 computes a minimum charging current that allows the necessary amount of charge to be supplied to the electricity storage apparatus 150 within the chargeable duration tcha. Then, the PLG-ECU 170 changes the charging current Ich for the electricity storage apparatus 150 from the pre-failure-detection minimum charging current to the minimum charging current computed subsequently to the detection of the power failure.

In step S26, the PLG-ECU 170 executes the charging of the electricity storage apparatus 150 with the post-adjustment charging current Ich. At this time, the PLG-ECU 170 controls the electric charger 160 (electric power conversion portion 190) so that the current supplied from the electric charger 160 to the electricity storage apparatus 150 becomes equal to the post-change minimum charging current (10 A).

SECOND MODIFICATION In conjunction with a second modification, adjustment of the charging current Ich performed in the case where a scheduled charging start time and a scheduled charging end time are specified by a user will be described.

FIG. 8 is a conceptual diagram for describing a second modification of the adjustment of the charging current Ich executed by the PLG-ECU 170. FIG. 8 assumes a case where in order to charge the electricity storage apparatus 150, the user has specified the scheduled charging start time and the scheduled charging end time in a late-night electricity rate period.

The charging schedule shown in FIG. 8 is different from that shown in FIG. 3B in that the scheduled charging start time is specified in addition to the scheduled charging end time. Specifically, in FIG. 8, the chargeable duration tcha is determined by the scheduled charging start time (0:00 midnight) and the scheduled charging end time (4:00 in the morning). In the assumed case in FIG. 8, the amount of remaining charge of the electricity storage apparatus 150 is SOC=50% as in the case shown in FIG. 3A.

In the second modification, the PLG-ECU 170 adjusts the charging current Ich to a minimum charging current (7.5 A) that allows the necessary amount of charge to be supplied to the electricity storage apparatus 150 within the chargeable duration tcha (4 h) and that is within the range of current that can be supplied from the external electric power supply 402.

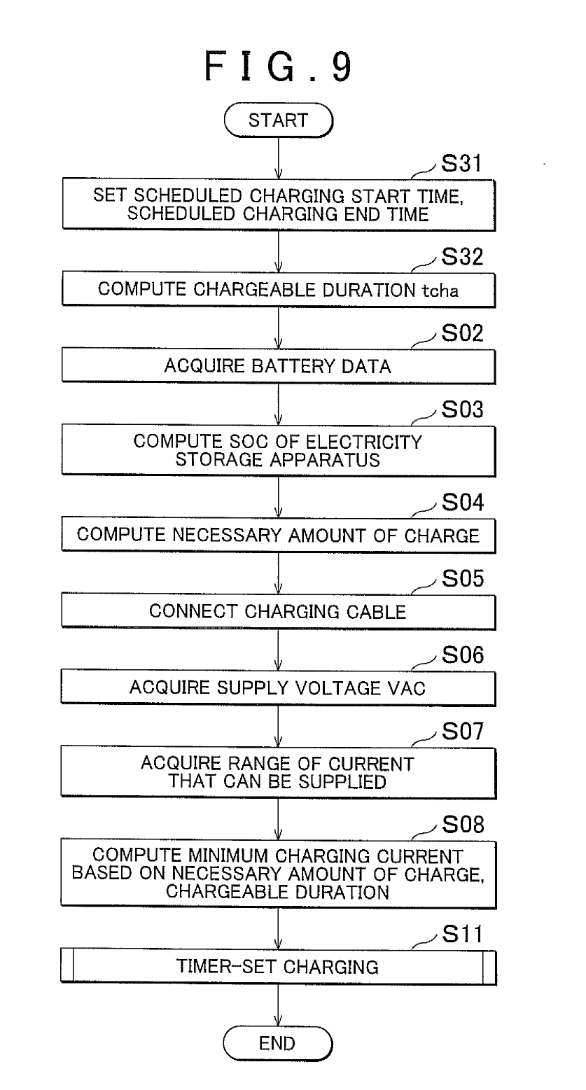

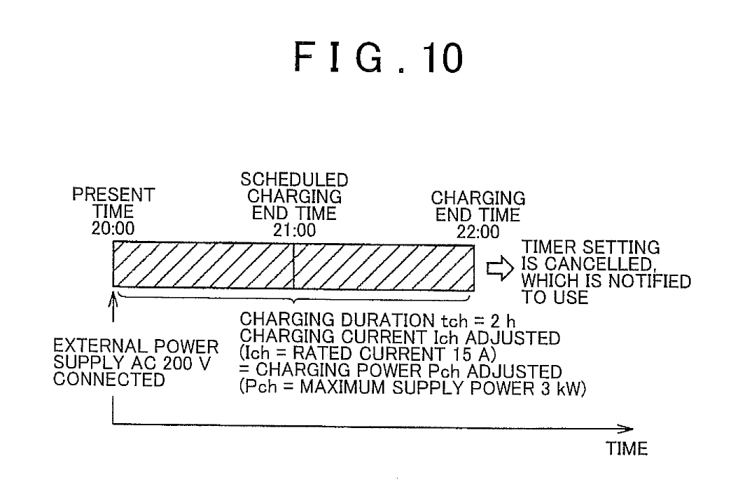

FIG. 9 is a flowchart showing a processing procedure of a timer-set charging control executed by the PLG-ECU 170 in an electric charging system in accordance with the second modification. The flowchart shown in FIG. 9 is different from the flowchart shown in FIG. 4 in that steps S31 and S32 are provided in place of steps S01, S09 and S10.

Referring to FIG. 9, after in step S31 the PLG-ECU 170 acquires the scheduled charging start time and the scheduled charging end time set by a user, the PLG-ECU 170 computes in step S32 the chargeable duration tcha determined by the specified scheduled charging start time and the specified scheduled charging end time.

The PLG-ECU 170 computes a minimum charging current in steps S02 to S08 as in the flowchart shown in FIG. 4. Then, the PLG-ECU 170 proceeds to step S11, in which the PLG-ECU 170 executes the timer-set electric charging process by using the scheduled charging start time.

THIRD MODIFICATION FIG. 10 is a conceptual diagram for describing a third modification of the adjustment of the charging electric power Pch that is executed by the PLG-ECU 170. FIG. 10 also assumes a case where the amount of remaining charge of the electricity storage apparatus 150 is SOC=50% as in FIG. 3A.

Referring to FIG. 10, in the case where the scheduled charging end time is set to 21:00, the chargeable duration tcha from the present time (20:00) to the scheduled charging end time (21:00) is 1 hour. This chargeable duration tcha is shorter than the minimum charging duration (tch=2 h) that is a charging duration needed in order to charge the electricity storage apparatus 150 with a maximum electric power (maximum supply electric power) that can be supplied from the external electric power supply 402. Therefore, it is determined that the charging cannot be completed by the scheduled charging end time.

In that case, the PLG-ECU 170 cancels the timer setting made by the user, and notifies the user of the cancellation by using the display portion 210. Furthermore, the PLG-ECU 170 charges the electricity storage apparatus 150 with the maximum supply electric power of the external electric power supply 402. At this time, the PLG-ECU 170 adjusts the charging current Ich to the rated current (15 A) of the charging cable 300. By cancelling the timer setting and charging the electricity storage apparatus 150 with the maximum supply electric power as described above, the charging of the electricity storage apparatus 150 is completed at 22:00.

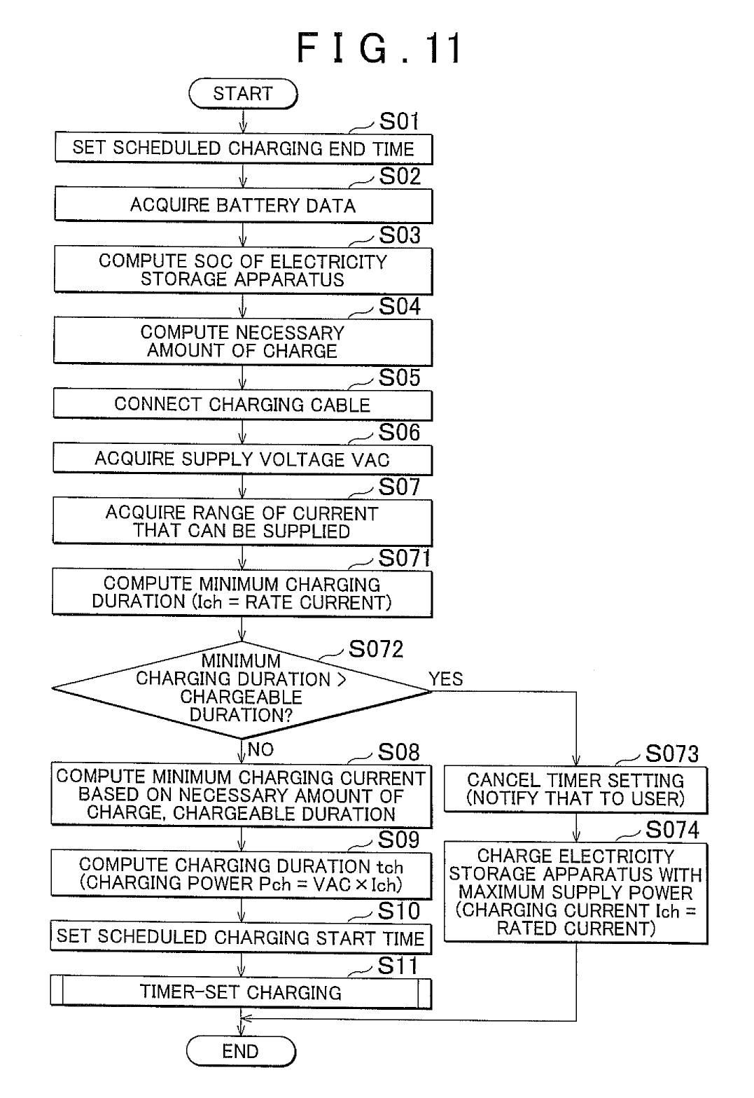

FIG. 11 is a flowchart showing a processing procedure of a timer-set charging control executed by the PLG-ECU 170 in an electric charging system in accordance with the third modification. The flowchart shown in FIG. 11, as compared with the flowchart shown in FIG. 4, further includes a process of steps S071 to S073.

Referring to FIG. 11, in step S071, the PLG-ECU 170 computes a charging duration (minimum charging duration) needed in order to charge the electricity storage apparatus 150 with the maximum supply electric power by using the rated current of the charging cable 300 acquired in step S07. Then, the PLG-ECU 170 determines in step S072 whether the minimum charging duration is longer than the chargeable duration from the present time to the scheduled charging end time. If the minimum charging duration is shorter than or equal to the chargeable duration (if the answer to step S072 is NO), the PLG-ECU 170 charges the electricity storage apparatus 150 with the minimum charging current in steps S08 to S11 as in FIG. 4.

On the other hand, if the minimum charging duration is longer than the chargeable duration (if the answer to step S072 is YES), the PLG-ECU 170 cancels the timer setting and notifies the user of the cancellation by using the display portion 210 in step S073.

Furthermore, in step S074, the PLG-ECU 170 charges the electricity storage apparatus 150 with the rated current of the charging cable 300 (i.e., with the maximum supply electric power).

Although the forgoing embodiments have been described in conjunction with an electric motor vehicle as a representative example of a vehicle to which an electric charging system in accordance with the invention is applied, the invention is applicable to vehicles that are equipped with an electricity storage apparatus constructed to be chargeable by an electric power supply provided outside the vehicle.

It is to be understood that the embodiments disclosed herein are illustrative and not restrictive in any respect. The scope of the invention is defined not by the foregoing description but by the appended claims, and is intended to cover all the modifications within the meaning and scope equivalent to those described in the appended claims.

What is claimed is:

1. An electric charging system for an electricity storage apparatus mounted in a vehicle, comprising:
an electric charger that converts electric power from an external electric power supply into charging electric power for the electricity storage apparatus;
an input portion configured to allow a scheduled charging end time for the electricity storage apparatus to be specified; and
a control apparatus configured to control the electric charger based on a charging schedule, wherein the control apparatus determines the charging schedule regarding charging current and charging duration for the electricity storage apparatus based on information pieces (i) to (iii) mentioned below:
(i) a necessary amount of charge that is an amount of charge that is needed in order to complete charging of the electricity storage apparatus;
(ii) the scheduled charging end time; and
(iii) a first current that is within a range of current suppliable from the external electric power supply and that is a minimum charging current that is needed in order to supply the necessary amount of charge to the electricity storage apparatus within a duration from a present time to the scheduled charging end time.

2. The electric charging system according to claim 1, wherein if the charging of the electricity storage apparatus is started at a time that is later than a scheduled charging start time that is set according to the first current and the scheduled charging end time, the control apparatus changes the first current to a minimum current that is needed in order to supply the necessary amount of charge to the electricity storage apparatus within a duration determined by the time at which the charging is actually started and the scheduled charging end time.

3. The electric charging system according to claim 1, wherein the input portion is configured to allow a scheduled charging start time for the electricity storage apparatus as well as the scheduled charging end time to be specified, and
wherein if the scheduled charging end time and the scheduled charging start time are specified via the input portion, the control apparatus determines the charging schedule based on a second current that is within the range of current suppliable from the external electric power supply and that is a minimum charging current that is needed in order to supply the necessary amount of charge to the electricity storage apparatus within a duration determined by the scheduled charging start time and the scheduled charging end time.

4. The electric charging system according to claim 3, wherein if the charging of the electricity storage apparatus is started at a time that is later than the scheduled charging start time specified via the input portion; the control apparatus changes the second current to a minimum current that is needed in order to supply necessary amount of charge to the electricity storage apparatus within a duration determined by the time at which the charging is actually started and the scheduled charging end time.

5. The electric charging system according to claim 1, wherein when the vehicle and the external electric power supply are connected by a charging cable, the control apparatus detects a range of current that is able to be conducted by the charging cable as the range of current suppliable from the external electric power supply.

6. The electric charging system according to claim 1, wherein the range of current suppliable from the external electric power supply is greater than or equal to a minimum value of current that the external electric power supply supplies and less than or equal to a rated current of the charging cable that connects the vehicle and the external electric power supply.

7. An electric charging method for an electricity storage apparatus mounted in a vehicle, comprising:
determining a charging schedule regarding charging current and charging duration for the electricity storage apparatus based on information pieces (i) to (iii) mentioned below:
(i) a necessary amount of charge that is an amount of charge that is needed in order to complete charging of the electricity storage apparatus,
(ii) a scheduled charging end time for the electricity storage apparatus, and
(iii) a first current that is within a range of current suppliable from an external electric power supply and that is a minimum charging current that is needed in order to supply the necessary amount of charge to the electricity storage apparatus within a duration from a present time to the scheduled charging end time; and
controlling an electric charger based on the charging schedule, wherein the electric charger converts electric power from the external electric power supply into charging electric power for the electricity storage apparatus.
